(19) United States
(12) Patent Application Publication
(10) Pub. No.: US 2017/0011265 A1
(43) Pub. Date: Jan. 12, 2017

(54) MONITORING METHOD FOR REGION

(71) Applicant: Taiwan Colour & Imaging Technology Corporation, Taipei (TW)

(72) Inventors: CHIH-AN SHAW, Taipei (TW); YIH-JONG WAN, Taipei (TW); TIEN-CHI WU, Taipei (TW)

(21) Appl. No.: 14/931,396

(22) Filed: Nov. 3, 2015

(30) Foreign Application Priority Data
Jul. 8, 2015 (TW) 104122234

(51) Int. Cl. G06K 9/00; G06T 7/60; G06Q 10/08; G10L 17/26; H04N 7/18; G08B 21/18; G10L 17/22

(52) U.S. Cl. CPC G06K 9/00771; G08B 21/18; G06T 7/602; G06K 9/00342; G06K 9/00255; G06K 9/00295; G06K 9/00275; G10L 17/22; G10L 17/26; H04N 7/183; G06K 9/00892; G06Q 10/087; G06T 2207/30232; G06T 2207/30242; G06T 2207/30196; G06T 2207/30201

(57) ABSTRACT

A monitoring method for a region includes capturing an image frame of a monitored region using an image capturing device, analyzing the image frame to obtain the image information of one or more target subject, receiving one or more wireless signal from one or more wireless transmitter by a wireless receiver, determining whether to generate a warning signal according to one or more identification (ID) code and the image information. The wireless signal includes the ID code, and for the cases of multiple wireless signals, each wireless signal has a different ID code.

### CROSS-REFERENCES TO RELATED APPLICATIONS

This non-provisional application claims priority under 35 U.S.C. §119(a) on Patent Application No. 104122234 filed in Taiwan, R.O.C. on Jul. 8, 2015 the entire contents of which are hereby incorporated by reference.

### BACKGROUND

### Technical Field

The instant disclosure relates to a monitoring method, in particular to a region monitoring method.

### Related Art

The field of factory floor monitoring has been one of the earlier applications of security surveillance. Since factories often deal with a large number of staff and goods, and the equivalent property price is much higher than other businesses, most factories have taken early action to incorporate security monitoring systems. As monitoring systems continue to evolve, the level of monitoring capabilities for factory settings has also been raised.

For factories, most of the current monitoring systems utilize employee badges and image capturing devices to monitor the flow of personnel entering or exiting a complex. For example, the security staff in the control room can view the captured images to identify any suspected person, or rely on a scanner to verify employee badges.

However, the use of monitoring systems for inventories has been neglected. For example, current systems cannot tell if the stored goods are of the correct quantity, or if the correct type of goods is stored, etc. As the storage capacity and/or goods quantity increases, the standard for proper inventory management also increases.

Additionally, more improvements are needed in the area of personnel management. Some examples may be an employee using someone else's ID badge, employees trespassing into unauthorized areas, a non-factory related individual misusing an ID badge to gain entry illegally, etc. These issues are unaccounted for by existing monitoring systems.

### SUMMARY

To address the above issues, the instant disclosure provides a region monitoring method.

In one embodiment, the method comprises: utilizing an image capturing device to obtain an image frame of a monitored region; analyzing the image frame to generate the image information for at least one target subject; receiving at least one wireless signal from at least one wireless transmitter by at least one wireless receiver; and determining whether to issue a warning signal based on at least one ID code and the image information. The wireless signal includes the ID code, and for multiple wireless signals, each wireless signal includes a different ID code.

In one embodiment, the method includes utilizing a biometric identification process to monitor at least one target subject in the monitored region.

Based on the above, the monitoring method of the instant disclosure can utilize the image and biometric identification procedures to monitor at least one target subject in the monitoring region. When an unusual situation arises for the target subject, the server can issue a warning signal. Therefore, the security staff or management members can be notified quickly to enhance monitoring efficiency.

### BRIEF DESCRIPTION OF THE DRAWINGS

FIG. 1 is a functional block diagram of a monitoring system for a first embodiment of the instant disclosure.

FIG. 2 is a functional block diagram of the monitoring system shown in FIG. 1.

FIG. 3 is a flowchart illustrating a monitoring method for one embodiment of the instant disclosure.

FIG. 4 is a schematic view of the monitoring system illustrated in FIG. 2.

FIG. 5 is a schematic view showing an image capturing device of FIG. 4 taking an image frame of a monitored region.

FIG. 6 illustrates one embodiment of the monitoring method shown in FIG. 3.

FIG. 7 is a schematic view illustrating a second embodiment of the monitoring system shown in FIG. 2.

FIG. 8 is a schematic view showing the image capturing device in FIG. 7 taking an image frame of the monitored region.

FIG. 9 is a flowchart illustrating one embodiment of the monitoring method shown in FIG. 6.

FIG. 10 is a flowchart illustrating another embodiment of the monitoring method shown in FIG. 3.

FIG. 11 is a flowchart illustrating one embodiment of the monitoring method shown in FIG. 10.

FIG. 12 is a flowchart illustrating a third embodiment of the monitoring method shown in FIG. 3.

FIG. 13 is a flowchart illustrating one embodiment of the monitoring method shown in FIG. 12.

FIG. 14 is a schematic view illustrating a third embodiment of the monitoring system shown in FIG. 2.

FIG. 15 is a flowchart illustrating a fourth embodiment of the monitoring method shown in FIG. 3.

### DETAILED DESCRIPTION

Please refer to FIG. 1, which shows a functional block diagram of a monitoring system in accordance with a first embodiment of the instant disclosure. The monitoring system comprises a wireless transmitter 10, a wireless receiver 20, an image capturing device 30, and a server module 40.

The monitoring system is capable of monitoring at least one target subject 50 in a monitored region, and the wireless transmitter 10 may be disposed on the target subject 50. The wireless transmitter 10 is communicable with the wireless receiver 20. The target subject 50 is monitored by electrically connecting the wireless receiver 20 and the image capturing device 30 to the server module 40. In some embodiments, the target subject 50 may be the personnel, a robot, an animal, goods, transport equipment, or other movable subject. The monitored region could be a factory entrance, an elevator entrance, a work area, etc.

The wireless transmitter 10 has a unique device ID, which can be carried by the transmitted signal. This way, the wireless signals provided by respective transmitters 10 can have different ID codes. Alternatively, an ID code can be assigned by a user to the wireless transmitter 10 to achieve the same effect. The identification code may include a media access control address (MAC address), the device ID of the wireless transmitter 10, or the unique identification code (UID) of the wireless transmitter 10.

Additionally, the wireless transmitter 10 and wireless receiver 20 may conform to the Bluetooth standard for signal transmission, preferably Bluetooth 4.0 or a higher standard.

The server module 40 may be a personal computer (PC), industrial-grade computer, a cloud server, or a medium having a processor and a storage unit. The server module 40 may be hardwired to the wireless receiver 20 and the image capturing device 30 by a USB or Ethernet cable. Wireless technology may also be utilized, such as Zigbee, Bluetooth, infrared, radio-frequency identification (RFID), Wifi, WiMax, 2G, 2.5G, 3G, 4G, etc.

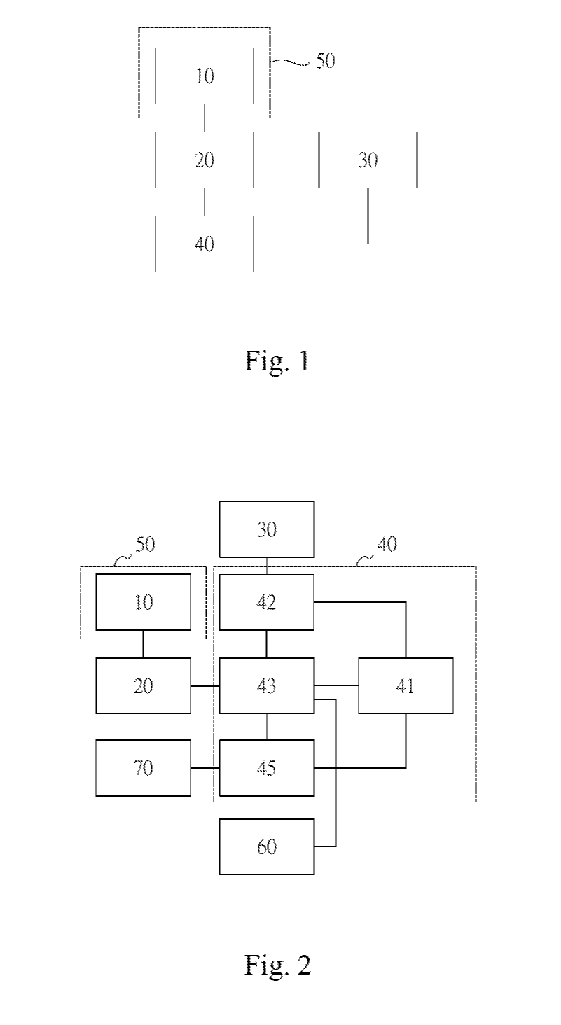

Please refer to FIG. 2, which is a functional block diagram showing one embodiment of the monitoring system illustrated in FIG. 1. In this embodiment, the monitoring system includes a mobile electronic device 60 and a microphone 70. The server module 40 further includes a memory unit 41, an image identification server 42, an event server 43, and a voiceprint identification server 45. The image identification server 42 is connected electrically to the image capturing device 30, the voiceprint identification server 45 is connected electrically to the microphone 70, and the wireless receiver 20 is connected electrically to the event server 43. The memory unit 41 is connected electrically to the image identification server 42, the event server 43, and the voiceprint identification server 45. The event server 43 is also connected electrically to the mobile electronic device 60.

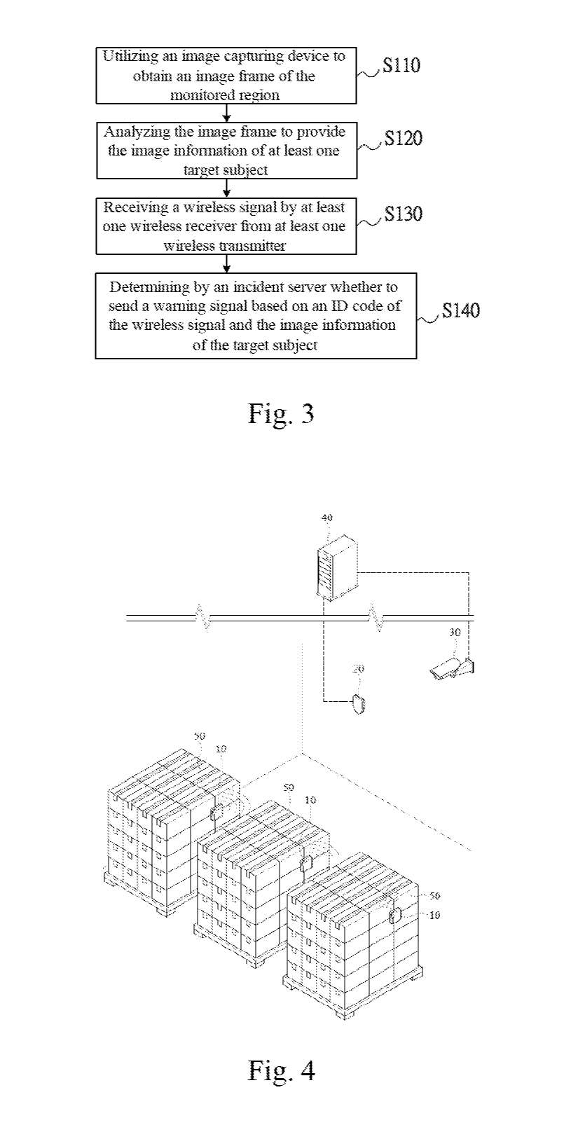

Please refer to FIG. 3, which is a flowchart illustrating one embodiment of a monitoring method of the instant disclosure. Please also refer to FIG. 2 in conjunction with FIG. 3. The monitoring method comprises: utilizing the image capturing device 30 to obtain an image of the monitored region (step S110); analyzing the image by the image identification server 42 to provide image information for the target subject 50 (step S120); receiving a wireless signal by the wireless receiver 20 from at least one wireless transmitter 10 (step S130); and determining by the event server 43 whether to send a warning signal based on the ID code of the wireless signal and the image information of the target subject 50 (step S140).

The event server 43 may transmit the warning signal wirelessly to the mobile electronic device 60 operable by the security staff or management personnel, such that the party may be notified of the unusual situation.

The abovementioned wireless communication can be performed through Zigbee, Bluetooth, infrared, RFID, Wifi, WiMax, 2G, 2.5G, 3G, or 4G. The mobile electronic device 60 may be a cellular phone, laptop computer, desktop computer, or tablet computer. Various embodiments of the monitoring system and method of the instant disclosure are provided below.

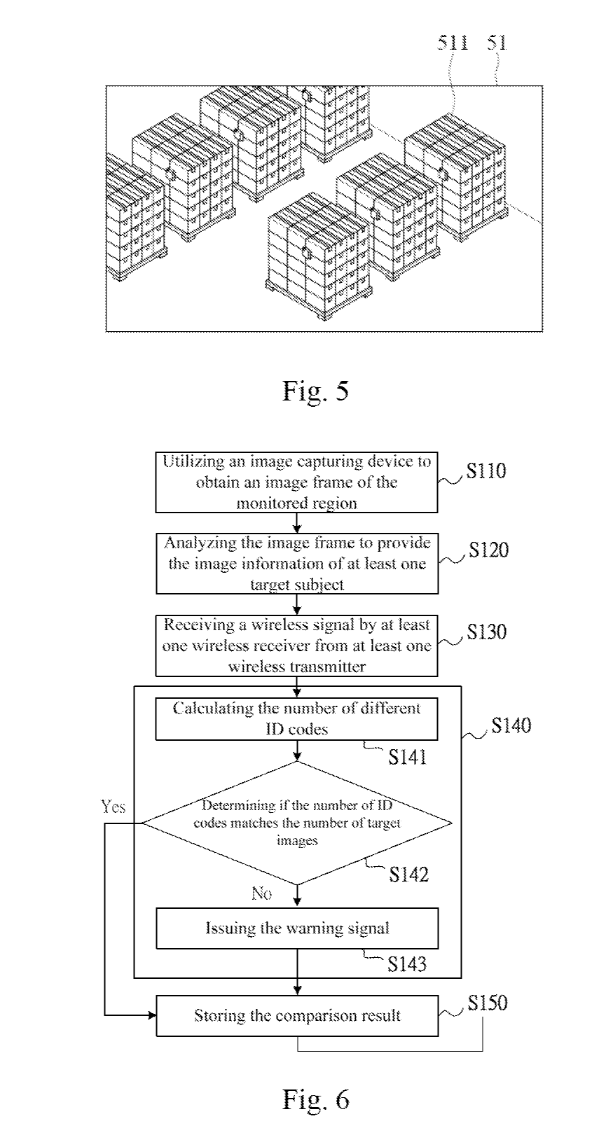

FIG. 4 is a schematic view of a first embodiment of the monitoring system illustrated in FIG. 2. FIG. 5 is a schematic view showing an image frame of the monitored region taken by the image capturing device 30 in FIG. 4. FIG. 6 is a flowchart illustrating a first embodiment of the monitoring method shown in FIG. 3. For some embodiments, the monitoring system may monitor the items (i.e., goods), stored in a warehouse. Please refer to FIGS. 4˜6, where the target subject 50 may be a single item or a collection of items (as shown in FIG. 4). To monitor the items, the wireless transmitters 10 may be fixedly or removably disposed on the items. For example, the wireless transmitters 10 may be glued or fixed to the outer packaging bags, containers, boxes, or tags of these items. And the wireless transmitters 10 are disposed on those items in a one-to-one manner. Therefore, based on the wireless signal sent by each of the wireless transmitters 10, the ID code of each wireless signal identifies a particular item. That is to say different items correspond to different ID codes.

The image capturing device 30 and the wireless receiver 20 may be disposed according to the storage area of these items, in particular to fixed locations in a warehouse. For example, the location may be a wall (as shown in FIG. 4), or a ceiling structure, such that the image capturing device 30 may capture an image frame 51 of the monitored region (as shown in FIG. 5), and the wireless receiver 20 may receive the wireless signal from the wireless transmitters 10. In some embodiments, if the monitored region is relatively large, a plurality of wireless receivers 20 and image capturing devices 30 may be arranged to eliminate any dead spot. The image capturing device 30 may be a web camera, internet protocol (IP) camera, digital camera, lens of a video camera on a personal computer, or any other device capable of image capturing and having internet accessibility.

Thus, after the image capturing device 30 has obtained the image frame 51 (step S110), the image frame 51 is sent by the image capturing device 30 to the image identification server 42. The image identification server 42 analyzes the received image frame 51 to provide the image information of the items (step S120). Meanwhile, the wireless receiver 20 receives different wireless signals from different items (step S130), and transmits those wireless signals to the event server 43. Based on the ID code of each wireless signal and the image information of the items, the event server 43 determines whether to send out the warning signal (step S140).

In some embodiments, the image frame 51 shows the number of item images 511 such that the image identification server 42 can analyze the contour of those images 511 and calculate how many of those images 511 are present. In addition, the event server 43 calculates the number of different ID codes (step S 141), to determine the number of wireless transmitters 10. Next, the event server 43 compares the number of item images 511 and the number of ID codes to determine if they match with each other (step S142). If the numbers do not match, the event server 43 proceeds to issue the warning signal (step S143). On the other hand, if the numbers match, the event server 43 does not issue the warning signal. In some embodiments, regardless whether the numbers match or not, the event server 43 records the comparison result in the memory unit 41 (step S150), so the warehouse staff can manage the stored items conveniently.

In other words, if the wireless receiver 20 receives a signal originated outside of the monitored region, the scenario is indicating that an item is stored at the wrong location (i.e., the number of item images 511 does not match the number of ID codes). In that case, the event server 43 issues the warning signal (step S143), to the mobile electronic device 60 so as to inform the staff to move the item to the correct location. By relocating the misplaced item, the number of item images becomes the same as the number of ID codes. For some embodiments, the warning signal may include the image frame 51 of the monitored region obtained by the image capturing device 30, such that the management staff may be informed about the monitored region in real time.

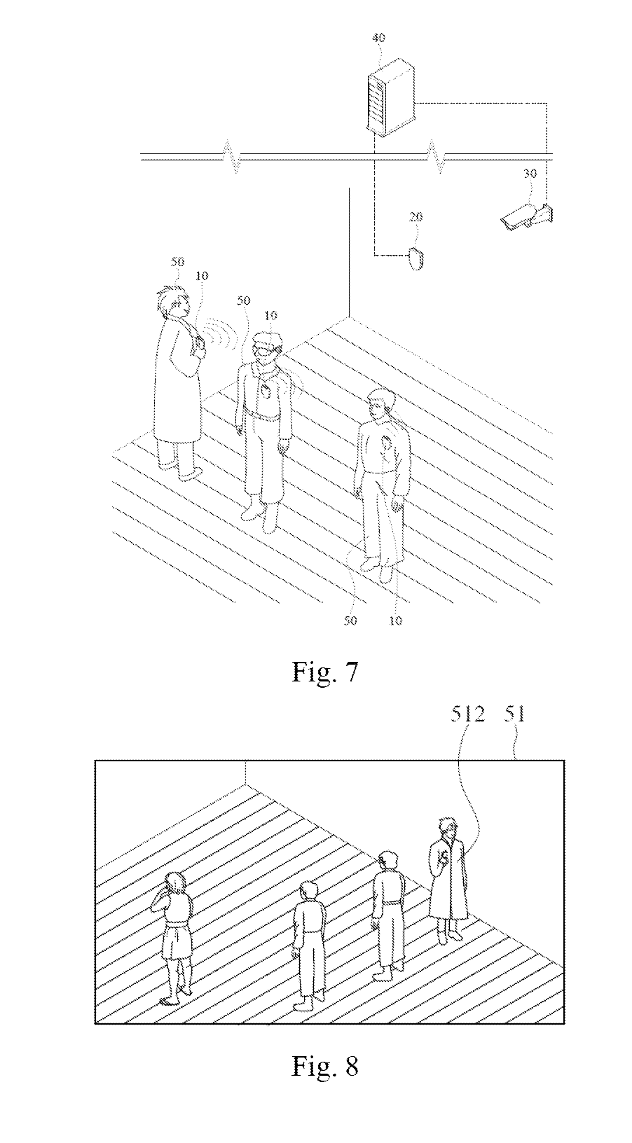

FIG. 7 is a schematic view of a second embodiment of the monitoring system illustrated in FIG. 2. FIG. 8 is a schematic view showing the image frame 51 of the monitored region obtained by the image capturing device 30 in FIG. 7. In some embodiments, the monitoring system can monitor the employees in a working area, in order to verify the identity of each employee. Please refer to FIGS. 6˜8, where the image capturing device 30 may be installed in the employee working area, in order to obtain the image frame 51 of the monitored region having at least one human-like image 512 (step S110). Each of the employees may wear one wireless transmitter 10 and matches one unique ID code. Thus, the image identification server 42 can analyze the facial image or body-like contour of the employee in the image frame 51 to calculate the number of human-like images 512 (step S120). The event server 43 calculates the number of ID codes (step S141), and determines if it matches the number of human-like images 512 (step S142). If the two numbers do not match, the event server 43 proceeds to issue the warning signal (step S143). Therefore, any employee leaving the work area without authorization or clock in for another employee may be detected (i.e., the number of human-like images 512 does not match the number of ID codes).

In some embodiments, the wireless transmitter 10 may be fit with the employee badge, uniform, or other accessory worn by the employee. In addition, the wireless signal outputted by the wireless transmitter 10 may further include employee number, work area, title, or any other work identification information.

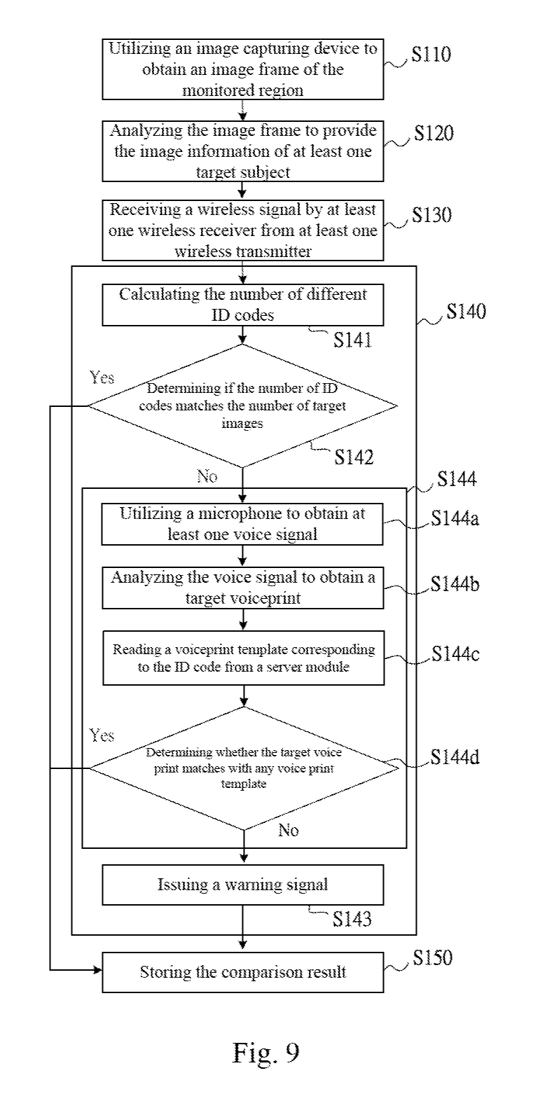

FIG. 9 is a flowchart of one embodiment of the monitoring method illustrated in FIG. 6. In some embodiments, when the image information derived from the monitored region and the wireless signal do not match with each other, the monitoring system can further use biometric verification technique to monitor any target subject in the monitored region. Please refer to FIG. 9, in which, taking employee monitoring as an example, once the event server 43 has determined that the number of ID codes is different from the number of human-like images 512 (step S142), the event server 43 initiates a biometric verification process (step S144), before proceeding to issue the warning signal (step S143).

For some embodiments, the biometric identification process may include fingerprint identification, voiceprint identification, or palm print identification. Taking voiceprint identification as an example, step S144 involves utilizing a microphone 70 to obtain a voice signal of every employee (step S144a). Then, the microphone 70 follows by transmitting the voice signals to a voice recognition server 45. The voice recognition server 45 analyzes the received voice signals to generate a target voiceprint for each of the employees (step S144b). Additionally, for every ID code, the memory unit 41 stores a corresponding voiceprint template, and the event server 43 reads the voiceprint templates corresponding to the ID codes associated with the monitored region (step S144c). The event server 43 then compares each of the target voiceprints with the voiceprint templates to determine if there is a match (step S144d). When a target voiceprint matches one of the voiceprint templates, the event server 43 does not issue the warning signal. However, if any of the target voiceprints does not match with any voiceprint template, the event server 43 proceeds to issue the warning signal (step S143). Therefore, in addition to monitoring the number of employees in a working area, the monitoring system can also verify the identity of each employee via the biometric identification process.

For the instant embodiment, the microphone 70 may be a microphone of a cellular phone, computer, or headset, but is not limited thereto. The microphone 70 may be any other voice capturing device.

For some embodiments, regardless whether a target voiceprint matches any voiceprint template or not, the event server 43 records the comparison result in the memory unit 41 (step S150).

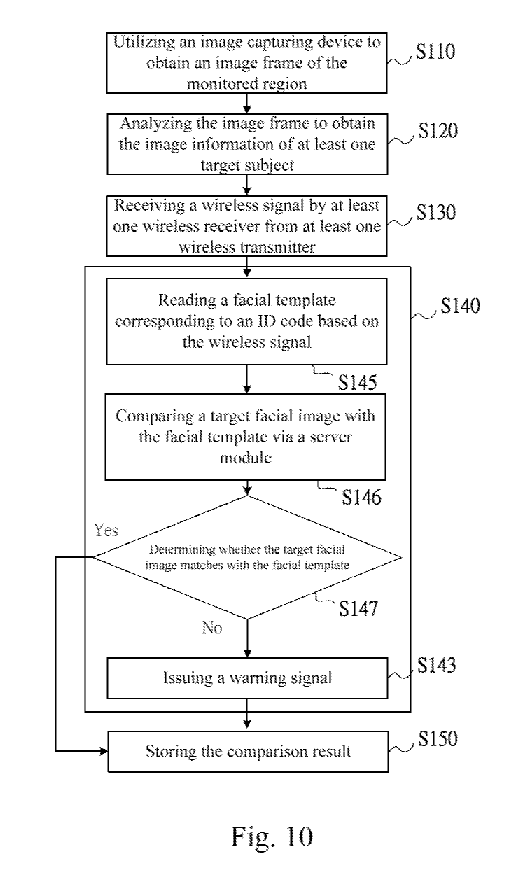

FIG. 10 is a flowchart of a second embodiment of the monitoring method illustrated in FIG. 3. In some embodiments and taking employee monitoring in a work area as an example, the memory unit 41 pre-records the facial image of every employee, with each facial image corresponding to an ID code. Then, the human-like image 512 obtained by the image capturing device 30 includes at least one facial image of an employee (for ease of explanation, the facial image captured by the image capturing device 30 is referred to as the target facial image). In this way, after the wireless receiver 20 has received the wireless signal from each employee, the event server 43 may read the facial images (for ease of explanation, these facial images are referred to as the facial templates), matching respective ID codes from the memory unit 41 based on the wireless signals. Based on the target facial image and facial templates, the event server 43 can determine whether or not to issue the warning signal. Please refer to FIG. 10, in step S140, based on the received wireless signals, the event server 43 reads the facial templates corresponding to respective ID codes in the memory unit 41 (step S145). The event server 43 then compares the target facial images with the facial templates in sequence (step S146), and determine if a match is found (step S147).

The event server 43 may also pick one target facial image and compare it with facial templates of all ID codes. When the target facial image matches any facial template, the event server 43 moves on to compare another target facial image with the facial templates, until all of the target facial images for the human-like images 512 have been compared. Alternatively, the event server 43 may select a facial template correspond to an ID code and compare it to all of the target facial images of the human-like images 512. When the selected facial template (corresponding to an ID code), matches any target facial image of a human-like image 512, the event server 43 moves on to select another facial template corresponding to another ID code and compare it to all of the target facial images of the human-like images 512, until the facial templates corresponding to all of the ID codes have been compared.

If each of the target facial images matches one facial template, the event server 43 does not send out the warning signal. However, if any target facial image does not match with a facial template, or any facial template does not match with a target facial image, the event server 43 sends out the warning signal (step S143).

In some embodiments, the target facial image may be an employee's front-view or side-view facial image. In step S146, when the event server 43 compares each target facial image with the facial templates, a similarity coefficient is generated based on the level of image likeness. In step S147, the event server 43 compares the similarity coefficient with an image threshold value to determine if any facial template matches a target facial image. If the similarity coefficient is substantially greater than or equal to the image threshold value, the relationship indicates a facial templates matches a target facial image. However, if the similarity coefficient is substantially less than the image threshold value, the relationship indicates none of the facial templates matches a target facial image. For example, if the image threshold value is 80%, when the similarity coefficient is substantially greater than or equal to 80%, the scenario indicates that a facial template matches a target facial image.

Alternatively, for some embodiments, the image frame 51 of the monitored region obtained by the image capturing device 30 may include at least one item image 511. The image identification server 42 analyzes the item image 511 to generate a target item image. Meanwhile, product templates of respective ID codes have been pre-stored in the memory unit 41. Based on the wireless signal, the event server 43 can read the product template corresponding to the particular ID code. Then, the event server 43 can compare each of the target item images to the item templates of all the ID codes to determine if there is a match. When each of the target item images matches one item template, the event server 43 does not send out the warning signal. However, when none of the target item images matches any product template, or none of the product templates matches any target item image, the event server 43 proceeds to send out the warning signal. In addition, based on the level of similarity between the target item image and the item template, the event server 43 may generate another similarity coefficient to determine if both images match with each other.

For some embodiments, regardless whether or not a facial template matches a target facial image, or a item template matches a target item image, the event server 43 records the comparison result in the memory unit 41 (step S150).

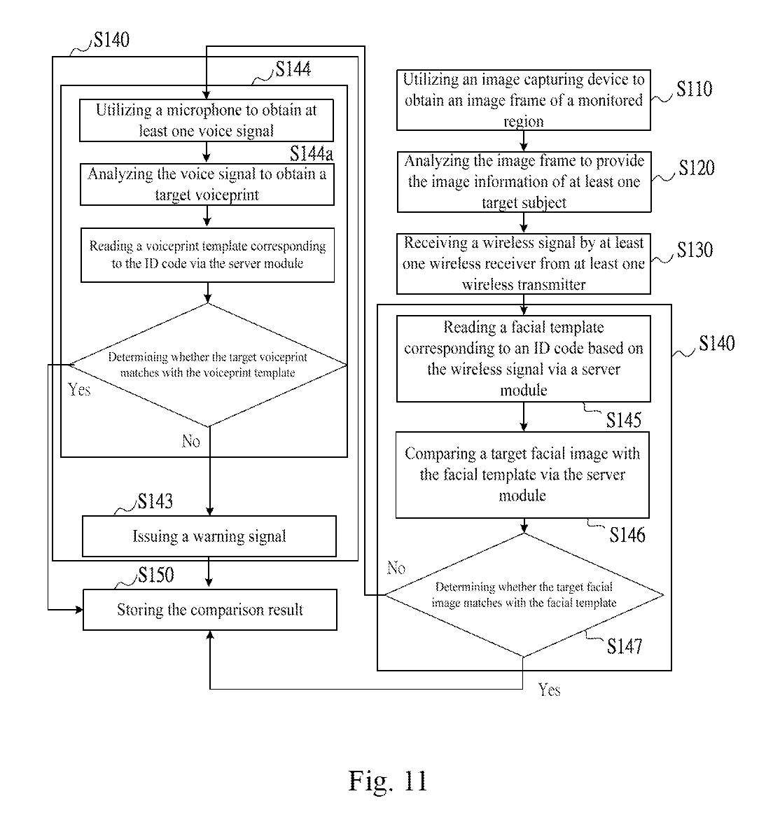

For some embodiments, when no match could be found between any facial template and a target facial image, the event server 43 may initiate a biometric identification process (step S144), before deciding whether to send out a warning signal. Please refer to FIG. 11, which illustrates one embodiment of the monitoring method shown in FIG. 10. In step S144, the biometrical identification process includes utilizing the microphone 70 to obtain a voice signal of at least one employee having a target facial image (step S144a). The voiceprint identification server 45 analyzes the voice signal to generate a target voiceprint (step S144b). On the other hand, based on the ID code of the wireless signal, the event server 43 reads a voiceprint template corresponding to the ID code from the memory unit 41 (step S144c). Then, the event server 43 compares the voiceprint template and the target voiceprint to determine if they are the same (step S144d). If they are different, the event server 43 proceeds to send out the warning signal (step S143). Therefore, besides comparing the facial images to monitor the work region, the monitoring system can also perform identity verification of every employee via the voiceprint identification process.

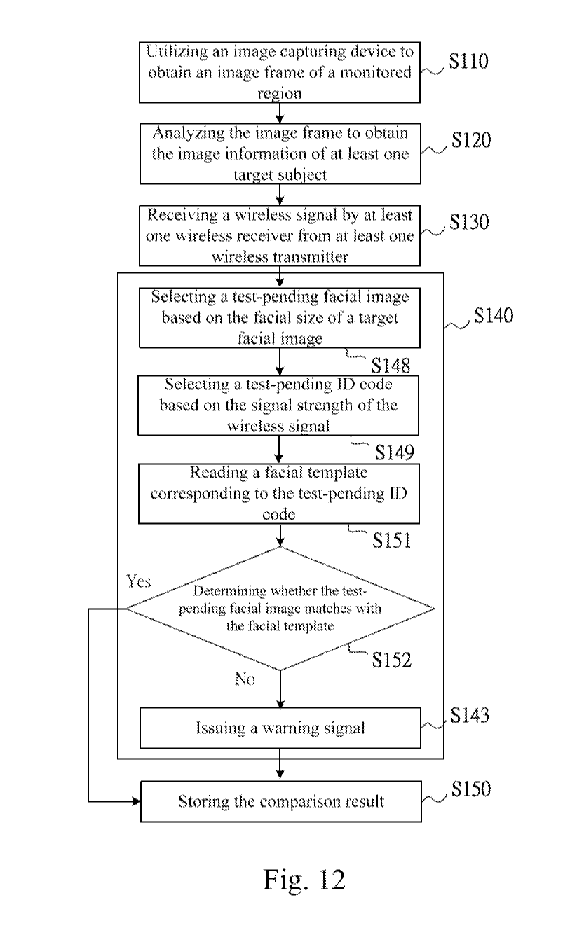

Please refer to FIG. 12, which illustrates a third embodiment of the monitoring method shown in FIG. 3. For some embodiments, the image capturing device 30 and the wireless receiver 20 may be installed at the same location. It should be noted that the distance between the employee and the image capturing device 30/wireless receiver 20 may be different for different employees. Therefore, each target facial image has different facial size, and each wireless signal has different signal strength. Hence, the event server 43 may start the comparison process beginning with the target facial image closest to the image capturing device 30 and the facial template corresponding to the wireless signal of the wireless transmitter 10 closest to the wireless receiver 20, in order to determine whether the warning signal should be sent. As shown in FIG. 12, in step S140, the event server 43 selects a test-pending facial image based on the facial size of each target facial image (step S148). Similarly, based on the signal strength of each wireless signal, the event server 43 selects a test-pending ID code (step S149). Then, based on the test-pending ID code, the event server 43 reads a facial template corresponding to the test-pending ID code from the memory unit 41 (step S150), in order to determine whether the test-pending facial image matches the facial template corresponding to the test-pending ID code (step S151).

For instance, the closer is the test-pending facial image to the image capturing device 30, the bigger is the facial size. The closer is the wireless signal to the wireless receiver 20, the stronger is the signal strength. From the target facial images, the event server 43 may pick the one with largest facial size as the test-pending facial image. Similarly, from the wireless signals, the event server 43 may pick the one with strongest signal strength as the test-pending ID code. Therefore, the monitoring system may verify the identity of the person closest to the image capturing device 30. In some embodiments, the aforementioned signal strength may be the received signal strength indicator (RSSI).

If the test-pending facial image matches the facial template, the match indicates the person closest to the image capturing device 30 has passed image identification verification, and the event server 43 does not proceed to issue the warning signal.

However, if there is not match, the event server 43 responds by issuing the warning signal (step S143).

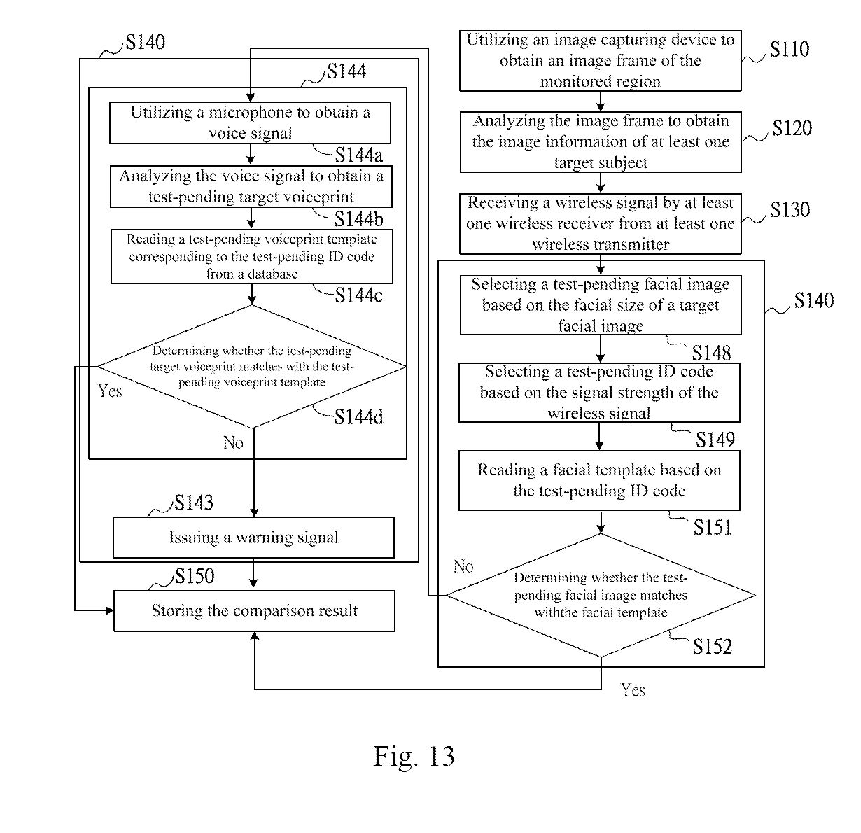

For some embodiments, if the test-pending facial image does not match with the facial template, the event server 43 initiates the biometric identification process (step S144), before deciding whether to send the warning signal. FIG. 13 illustrates one embodiment of the monitoring method shown in FIG. 12. As shown in step S144 and taking voiceprint identification as an example, the biometric identification process includes utilizing the microphone 70 to obtain a voice signal of the person closest to the image capturing device 30 (step S144a), as the test-pending voice signal. The microphone 70 then outputs the voice signal to the voiceprint identification server 45, such that the voiceprint identification server 45 can analyze the received signal to generate a test-pending target voiceprint (step S144b). Next, the event server 43 reads a test-pending voiceprint template corresponding to the test-pending ID code from the memory unit 41 (step S144c), such that the event server 43 can compare the test-pending target voiceprint with the test-pending voiceprint template (step S144d), for identity verification. If both voiceprints match up with each other, the event server 43 does not issue the warning signal. If not, the event server 43 issues the warning signal (step S143).

In step S144d, the event server 43 can generate a voiceprint similarity coefficient when comparing the level of similarity between the test-pending target voiceprint and the test-pending voiceprint template. If the voiceprint similarity coefficient is substantially greater than or equal to a voiceprint threshold value, the scenario suggests the test-pending target voiceprint is the same as the test-pending voiceprint template. However, if the voiceprint similarity coefficient is substantially less than the voiceprint threshold value, the scenario is indicating the test-pending target voiceprint does not match with the test-pending voiceprint template.

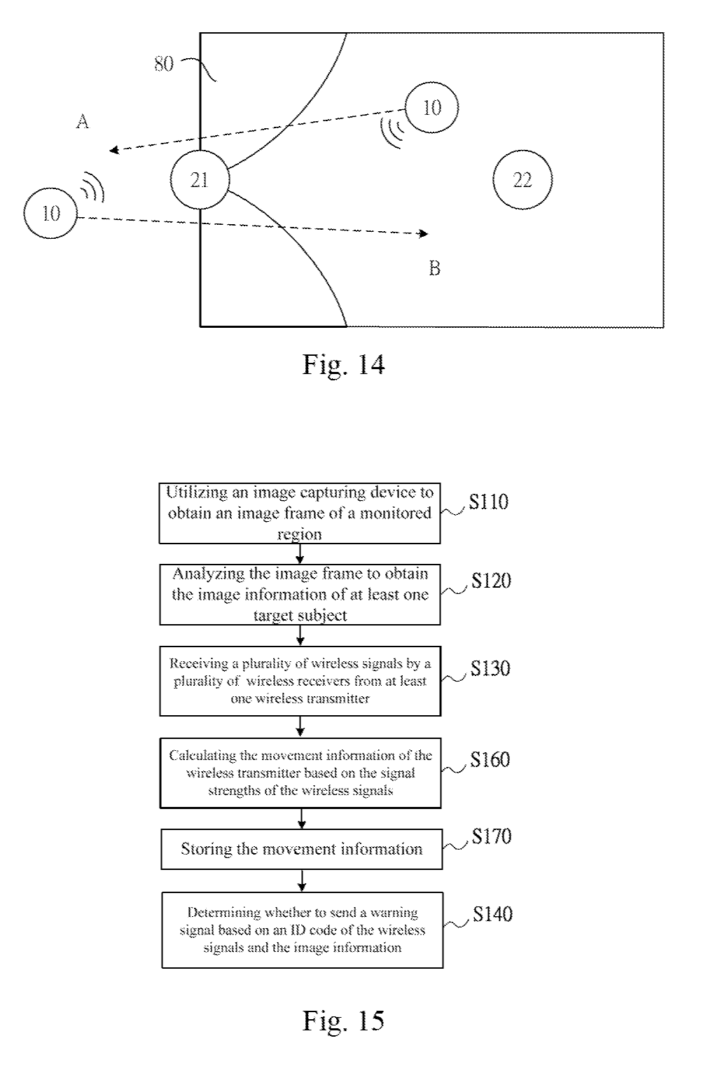

Please refer to FIG. 14, which illustrates a third embodiment of the monitoring system shown in FIG. 2. In some embodiments, the monitoring system is capable of monitoring employees entering or exiting a main gate 80 of the work area and determining movement information of the employees. As shown in FIG. 14, the monitoring system comprises a pair of wireless receivers (for ease of explanation, the receivers are referred to as a first wireless receiver 21 and a second wireless receiver 22). The first wireless receiver 21 may be disposed at a first position, while the second wireless receiver 22 may be disposed at a second position different from the first position. For example, the first wireless receiver 21 may be fixedly disposed on top of the main gate 80, and the second wireless receiver 22 may be fixedly disposed on a side portion of the main gate 80. Thus, through the first and second wireless receivers 21 and 22, the event server 43 may receive the wireless signal sent by the wireless transmitter 10 to calculate movement information of an employee relative to the main gate 80. That is, the employee may be entering, leaving, or staying around the work area (as shown in FIG. 14, a first direction A represents leaving the main gate 80, and a second direction B represents entering the main gate 80.).

Next, please refer to FIG. 15, which illustrates a fourth embodiment of the monitoring method shown in FIG. 3. After the event server 43 has received the wireless signals from the wireless transmitter 10 via the first and second wireless receivers 21 and 22 (step S130), the event server 43 may calculate the movement information of the wireless transmitter 10 based on the signal strengths of the wireless signals at different instants in time (step S160). More specifically, the first wireless receiver 21 receives a first wireless signal from the wireless transmitter 10 at a first instant in time. The second wireless receiver 22 receives a second wireless signal from the wireless transmitter 10 at the first instant in time. Then, the first wireless receiver 21 receives a third wireless signal from the wireless transmitter 10 at a second instant in time later than the first instant in time. The second wireless receiver 22 receives a fourth wireless signal from the wireless transmitter 10 at the second instant in time.

The first, second, third, and fourth wireless signal have a first, second, third, and forth signal strength, respectively. In addition, the first, second, third, and fourth wireless signals all have a first ID code. Therefore, the event server 43 may compare the signal strengths between the first and third wireless signals and between the second and fourth signals, in order to determine the movement information of the wireless transmitter 10 corresponding to the first ID code.

If the first signal strength is greater than the third signal strength, and the second signal strength is less than the fourth signal strength, the scenario indicates the wireless transmitter 10 is moving from the first position to the second position. In other words, the wireless transmitter 10 is moving away from the first position and toward the second position. That is to say the employee is entering the main gate 80 (second direction B). For example, if the RSSI values for the first, third, second, and fourth signal strength are 8, 5, 2, and 9, respectively, the values indicate the employee is entering the main gate 80. However, if the first signal strength is less than the third signal strength, and the second signal strength is greater than the fourth signal strength, the scenario is indicating the wireless transmitter 10 is moving from the second position toward the first position. In other words, the wireless transmitter 10 is moving away from the second position and toward the first position. That is to say the employee is exiting the main gate 80 (first direction A). For example, if the RSSI values for the first, third, second, and fourth signal strengths are 5, 8, 9, and 2, respectively, the values indicate the employee is leaving the main gate 80. Moreover, if the first signal strength is the same as the third signal strength, and the second signal strength is the same as the fourth signal strength, the scenario is indicating the employee is staying in the work area.

Thus, for some embodiments, the event server 43 may record the movement information of the employee in the memory unit 41 (step S170). If one or more wireless transmitter 10 shows abnormality, the event server 43 may issue the warning signal that includes the movement information to the mobile device, in order to notify the management staff. For example, if the number of ID codes and the number of target images do not match, the target voiceprint and the voiceprint template do not match, the target facial image and the facial template do not match, the target item image and the item template do not match, or the test-pending facial image and the test-pending facial template do not match, the event server 43 will send out the warning signal. Thus, based on the warning signal, the management staff may be notified of the movement information of the wireless transmitter 10 showing unusual activity, such as entering or leaving the main gate 80 or staying in the work area.

Based on the above, the monitoring method of the instant disclosure utilizes the monitoring system to monitor at least one target subject in a monitored area, via the image and biometric identification process. If any target subject shows unusual activity, the server responds by sending the warning signal. Thus, the monitoring or management staff may be notified quickly to enhance monitoring efficiency.

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A monitoring method applicable to monitor at least one target subject in a monitored region, comprising:
utilizing an image capturing device to obtain an image frame of the monitored region;
analyzing the image frame to generate the image information of the target subject;
utilizing a wireless receiver to receive at least one wireless signal from at least one wireless transmitter, the wireless signal including an unique identification (ID) code; and
determining whether to issue a warning signal based on the ID code and the image information;
wherein for a plurality of wireless signals, each of the wireless signals has a different ID code.

2. The monitoring method of claim 1, wherein the image information includes the number of target images of the target subject, wherein for the step of determining whether to issue the warning signal further includes:
calculating the number of ID codes;
determining if the number of ID codes matches the number of target images; and
issuing the warning signal when the number of ID codes is different from the number of target images, wherein if the number of ID codes matches the number of target images, the warning signal is not issued.

3. The monitoring method of claim 1, further comprising utilizing an image identification server to analyze the image information to determine the number of target images as part of the image information, and wherein for the step of determining whether to issue the warning signal further includes:
utilizing an event server to calculate the number of ID codes;
determining whether the number of ID codes matches the number of target images by the event server;
issuing the warning signal by the event server when the number of ID codes does not match with the number of target images, and wherein if the number of ID codes matches the number of target images, the event server does not issue the warning signal.

4. The monitoring method of claim 1, wherein the image information includes a target facial image of the target subject, and wherein for the step of determining whether to issue the warning signal further includes:
reading a facial template corresponding to the ID code from a server module;
comparing the target facial image with the facial template;
issuing the warning signal when no target facial image matches the facial template or when no facial template matches the target facial image, and wherein if the target facial image matches the facial template, no warning signal is issued.

5. The monitoring method of claim 1, wherein the image information includes at least one facial image having a facial size, wherein the wireless signal further has a signal strength, and wherein the step of determining whether to issue the warning signal further includes:
selecting a test-pending facial image based on the facial size;
selecting a test-pending ID code based on the signal strength;
reading a facial template corresponding to the test-pending ID code from a server module;
comparing the test-pending facial image with the facial template; and
issuing the warning signal when the test-pending facial image does not match with the facial template, and wherein if the test-pending facial image matches the facial template, no warning signal is issued.

6. The monitoring method of claim 1, wherein the image information includes the number of target images of the target subjects, and wherein the step of determining whether to issue the warning signal further comprises:
calculating the number of ID codes;
determining if the number of ID codes matches the number of target images; and
initiating a biometric identification process when the number of ID codes does not match with the number of target images, and determining whether to issue the warning signal based on a comparison result of the biological identification process, and wherein when the number of ID codes matches the number of target images, no warning signal is issued.

7. The monitoring method of claim 6, wherein the biometric identification process includes:
utilizing a microphone to obtain a voice signal;
analyzing the voice signal to obtain a target voiceprint;
reading a voiceprint template corresponding to the ID code from a server module;
comparing the target voiceprint with the voiceprint template;
issuing the warning signal when the target voiceprint does not match with the voiceprint template, and wherein if the target voiceprint matches the voiceprint template, no warning signal is issued.

8. The monitoring method of claim 7, wherein the server module includes a voiceprint identification server, and wherein for the step of analyzing the voice signal, the voiceprint identification server receives the voice signal to generate the target voiceprint.

9. The monitoring method of claim 1, wherein the image information includes a target facial image of the target subject, and wherein for the step of determining whether to issue the warning signal further includes:
reading a facial template corresponding to the ID code from a server module;
comparing the target facial image with the facial template;
initiating a biometric identification process when no target facial image matches the facial template or when no facial template matches the target facial image, and determining whether to issue the warning signal based on the result of the biometric identification process, and if the target facial image matches the facial template, no warning signal is issued.

10. The monitoring method of claim 9, wherein the biometric identification process includes:
utilizing a microphone to obtain a voice signal;
analyzing the voice signal to obtain a target voiceprint;
reading a voiceprint template corresponding to the ID code from a server unit;
comparing the target voiceprint to the voiceprint template, and wherein the warning signal is issued when the target voiceprint does not match with the voiceprint template, and if the target voiceprint matches the voiceprint template, the warning signal is not issued.

11. The monitoring method of claim 10, wherein the server module includes a voiceprint identification server, and wherein for the step of analyzing the voice signal, the voiceprint identification server receives the voice signal to obtain a target voiceprint.

12. The monitoring method of claim 1, wherein the image information includes at least one target facial image having a facial size, wherein the wireless signal has a signal strength, and wherein the step of determining whether to issue the warning signal further comprises:
selecting a test-pending facial image based on the facial size;
selecting a test-pending ID code based on the signal strength;
reading a facial template corresponding to the test-pending ID code from a server module;
comparing the test-pending facial image with the facial template; and
initiating a biometric identification process when the test-pending facial image does not match with the facial template and determining whether to issue the warning signal based on the result of the biometric identification process, and if the test-pending facial image matches the facial template, no warning signal is issued.

13. The monitoring method of claim 12, wherein the biometric identification process includes:
utilizing a microphone to obtain a voice signal;
analyzing the voice signal to obtain a target voiceprint;
reading a voiceprint template corresponding to the ID code from a server module;
comparing the target voiceprint to the voiceprint template; and
issuing the warning signal when the target voiceprint does not match with the voiceprint template, and wherein if the target voiceprint matches the voiceprint template, no warning signal is issued.

14. The monitoring method of claim 13, wherein the server module includes a voiceprint identification server, and wherein for the step of analyzing the voice signal, the voiceprint identification server receives and analyzes the voice signal to obtain the target voiceprint.

15. The monitoring method of claim 1, wherein the wireless receiver is disposed at a first position and receives at least one first wireless signal at a first instant in time from at least one wireless transmitter, wherein the first wireless signal has a first ID code and a first signal strength, wherein the method further comprises;
utilizing another wireless receiver to receive at least one second wireless signal at the first instant in time from the wireless transmitter, with the second wireless signal having the first ID code and a second signal strength, and the other wireless receiver is disposed at a second position different from the first position;
utilizing the first wireless receiver to receive at least one third wireless signal at a second instant in time from the wireless transmitter, with the third wireless signal having the first ID code and a third signal strength, and the second instant in time is later than the first instant in time;
utilizing the other wireless receiver to receive at least one fourth wireless signal at the second instant in time from the wireless transmitter, with the second wireless signal having the first ID code and a fourth signal strength; and
determining the movement information of the wireless transmitter represented by the first ID code based on the first, second, third, and fourth signal strength;
and wherein the warning signal indicates the wireless transmitter is showing an abnormality and includes the movement information of the abnormal wireless transmitter.

16. The method of claim 15, further comprising:
comparing the first signal strength with the third signal strength; and
comparing the second signal strength with the fourth signal strength;
wherein when the first signal strength is greater than the third signal strength, and when the second signal strength is less than the fourth signal strength, the corresponding movement information indicates the wireless transmitter is moving from the first position toward the second position; and
wherein when the first signal strength is less than the third signal strength, and when the second signal strength is greater than the fourth signal strength, the corresponding movement information indicates the wireless transmitter is moving from the second position toward the first position.

17. The method of claim 15, wherein the monitored region is a main gate, with the first and second positions located outside and inside of the main gate, respectively, wherein the method further comprises:
comparing the first signal strength with the third signal strength; and
comparing the second signal strength with the fourth signal strength;
wherein when the first signal strength is greater than the third signal strength, and when the second signal strength is less than the fourth signal strength, the corresponding movement information indicates the wireless transmitter is entering the main gate; and
wherein when the first signal strength is less than the third signal strength, and when the second signal strength is greater than the fourth signal strength, the corresponding movement information indicates the wireless transmitter is exiting the main gate.

18. The method of claim 1, wherein the wireless transmitter is a Bluetooth transmitter and the wireless receiver is a Bluetooth receiver.

19. The method of claim 1, wherein the wireless transmitter is disposed on the target subject.

20. The method of claim 1, wherein for the step of determining whether to issue the warning signal, a server module is utilized to determine whether to issue the warning signal, and wherein if the server module decides to issue the warning signal, the warning signal is sent to a mobile electronic device.
